(19) United States
(12) Patent Application Publication
(10) Pub. No.: US 2008/0112349 A1
(43) Pub. Date: May 15, 2008

(54) SYSTEM AND METHOD FOR PROVIDING INTERNET PROTOCOL MULTICAST COMMUNICATIONS OVER A WIRELESS BROADBAND DATA NETWORK

(75) Inventors: ADAM C. LEWIS, BUFFALO GROVE, IL (US); DAH-LAIN A. TANG, NAPERVILLE, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/559,319

(22) Filed: Nov. 13, 2006

(51) Int. Cl. H04H 20/71

(52) U.S. Cl. 370/312

(57) ABSTRACT

A system and method is provided for enabling operation of a native Internet Protocol (IP) multicast application in a mobile station having a wireless interface that does not support native IP multicast messages. The mobile station includes a link layer interface that is configured to communicate with various base stations using a wireless broadband data protocol. Each mobile station also includes a proxy module that operates as a middleware layer above the link layer interface. The proxy module is configured to intercept multicast messages being passed to and from the link layer interface, and convert any multicast messages from a native IP multicast protocol, to an Application Program Interface (API) call specific to the link layer interface, or vice versa.

### TECHNICAL FIELD OF THE DISCLOSURE

This disclosure relates generally to wireless broadband data systems, and more particularly, to a system and method for providing Internet Protocol (IP) multicast communications over a wireless broadband data network.

### BACKGROUND OF THE DISCLOSURE

Recently, a number of wireless broadband data protocols have been developed to provide more effective techniques for transmitting data in a wireless communication system. One example of such a protocol is Evolution Data Optimized, often abbreviated as EvDO, which has been adopted by many Code Division Multiple Access (CDMA) mobile phone providers as part of the CDMA2000 standard. In typical systems using EvDO, mobile stations (such as computers, cellular phone, personal digital assistants (PDAs), and the like) wirelessly connect to a network via an EvDO interface (such as a personal computer (PC) card, a modem, a router, or the like).

EvDO is an IP based communication protocol. That is, each computer or device in the system is assigned a unique IP address. Data is then broken up into packets, each of which can be transmitted independently to a specified IP address. Data transmissions within the system may also be either unicast transmissions or multicast transmissions. For example, in unicast transmissions, a one-to-one client/server relationship is established where the client receives a distinct data stream from the server. By contrast, in multicast transmissions, a single data stream is sent to multiple recipients as a group transmission. Multicast transmissions therefore conserve significant bandwidth by simultaneously delivering a single stream of information to multiple recipients rather than having to create a separate data stream for each of the recipients. Today, there are multiple applications that take advantage of multicasting, include videoconferencing, corporate communications, distance learning, and distribution of software, stock quotes, news, and emergency alert systems.

In EvDO systems, multicasting is provided using the Broadcast and Multicast Service (BCMCS) protocol, which is generally defined in 3GPP2X.S0022-0 from the 3^{rd} Generation Partnership 2 Project (3GPP2). Specifically, the BCMCS protocol allows for multicast delivery of BCMCS content streams to one or more hosts in a communication network. However, one significant drawback of the BCMCS protocol is that it does not support native IP multicasting using, for example, Internet Group Management Protocol (IGMP). Therefore, to use multicasting features in a mobile station having an EvDO interface, the mobile station must include a multicast application configured to communicate with the EvDO interface using an EvDO-defined Application Program Interface (API) signaling. As a result, EvDO enabled mobile stations cannot support off-the-shelf (OTS) multicast applications, which are typically configured to use native IP multicast standards. This significantly limits the applications that may be used in EvDO enabled mobile stations and instead requires users to purchase/develop and use proprietary EvDO-based multicast applications.

Accordingly, there is a need for a system and method for operating a native IP multicast application in a mobile device which uses a wireless broadband data protocol that does not support native IP multicasting.

### BRIEF DESCRIPTION OF THE FIGURES

Various embodiment of the disclosure are now described, by way of example only, with reference to the accompanying figures.

FIG. 1 shows one embodiment of a communication system according to the present disclosure.

FIG. 2 shows one embodiment of a multi-layer structure for a mobile station according to the present disclosure.

FIG. 3 shows one embodiment of a method for transmitting a multicast message from the mobile station according to the present disclosure.

FIG. 4 shows one embodiment of a method for receiving a multicast message at a mobile station according to the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help improve the understanding of various embodiments of the present disclosure. Also, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions with respect to their corresponding respective areas of inquiry and study except where specific meaning have otherwise been set forth herein.

### DETAILED DESCRIPTION OF THE DISCLOSURE

The present disclosure provides a system and method for operating a native IP multicast application in a mobile station having a wireless interface that offers broadcast and/or multicast services but does not support native IP multicast messages. In particular, the mobile station includes a link layer interface that is configured to communicate with various base stations using a wireless broadband data protocol, such as EvDO. Each mobile station also includes a proxy module that operates as a middleware layer above the link layer interface. In accordance with the present disclosure, the proxy module is configured to intercept and/or suppress multicast messages being passed to and from the link layer interface, and convert any multicast messages from a native IP multicast protocol, such as IGMP, to an API call specific to the link layer interface, or vice versa. For example, when a multicast application triggers a native IP multicast message, such as an IGMP report, a multicast IP packet, or the like, the proxy module is configured to intercept the IP multicast message before it reaches the link layer interface, and convert the IP multicast message to an interface-specific into a format understood by the interface and the network to which it is associated. The API call is then received by the link layer interface, which generates the appropriate multicast message using the wireless broadband data protocol and transmits the multicast message to the base station. Similarly, if a multicast message using the wireless broadband data protocol is received by the link layer interface, the link layer interface may generate an API call corresponding to the received multicast message. The proxy module is configured to obtain the API call from the link layer interface, convert it to a native IP multicast message, and pass the IP multicast message up to the native multicast application.

Let us now discuss the present disclosure in greater detail by referring to the figures below. For clarity and exemplary purposes only, the following description and examples assume a CDMA2000 system using the EvDO and BCMCS protocols. However, the present disclosure is also applicable to wireless communication systems using other types of access schemes or other types of wireless broadband protocol, e.g., Wideband Code Division Multiple Access (WCDMA) using Universal Mobile Telecommunications System (UMTS), Global System for Mobile communication (GSM) using Enhanced Data rates for Global Evolution (EDGE) or General Packet Radio Service (GPRS), or the like.

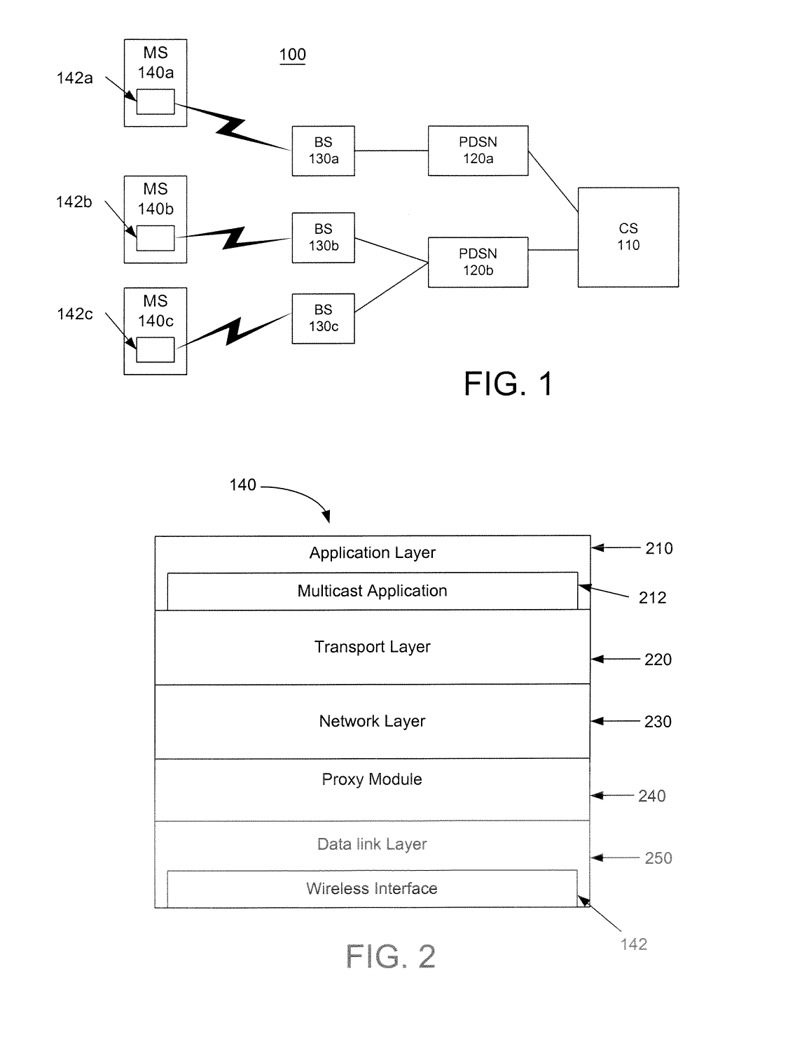

FIG. 1 illustrates an exemplary wireless communication system 100 that is capable of providing multicast transmissions in accordance with the present disclosure. The system 100 includes a content server (CS) 110 that provides IP packets by compressing data communications such as, for example, image and/or voice data, according to an IP. The content server 110 delivers the IP packets to base stations (BS) 130a, 130b and 130c via packet data serving nodes (PDSNs) 120a and 120b over a packet communication network such as the Internet. It should be noted that the packet data serving node may also comprise a broadcast serving node. Each of the base stations 130a, 130b, and 130c may further be comprised of a base transceiver subsystem (BTS), a base station controller (BSC), and a packet control function unit (PCF). As the content server 110, packet data serving nodes 120a and 120b, and base stations 130a, 130b, and 130c are each conventional components of a communication system, their functionality is not described in any more detail herein.

As shown in FIG. 1, the system 100 also includes mobile stations (MSs) 140a, 140b, and 140c, which may be, for example, cellular phones, Personal Digital Assistants (PDAs), video terminals, portable computers with a wireless modem, or any other wireless devices. Each of the mobile stations 104a, 140b, and 140c includes a wireless interface 142a, 142b, and 142c that enables communications with a respective base station 130a, 130b, and 130c, using wireless resources such as, for example, CDMA2000. The wireless interface may be a PC card, a router, a modem, a radio module, or any other type of known interface. In one exemplary embodiment of a CDMA2000 system, the wireless interface may be an EvDO interface that is configured to provide wireless broadband transmission using the EvDO and BCMCS protocols.

Of course, practitioners skilled in the art would also understand that the system 100 may also include other additional components. For example, the system 100 may include Authentication, Authorization, and Accounting (AAA) servers, subscriber profile managers, and subscriber profile databases, and the like. Although only one mobile station is illustrated in communication with each base station, it is also understood that any number of mobile stations may be in communication with each base station.

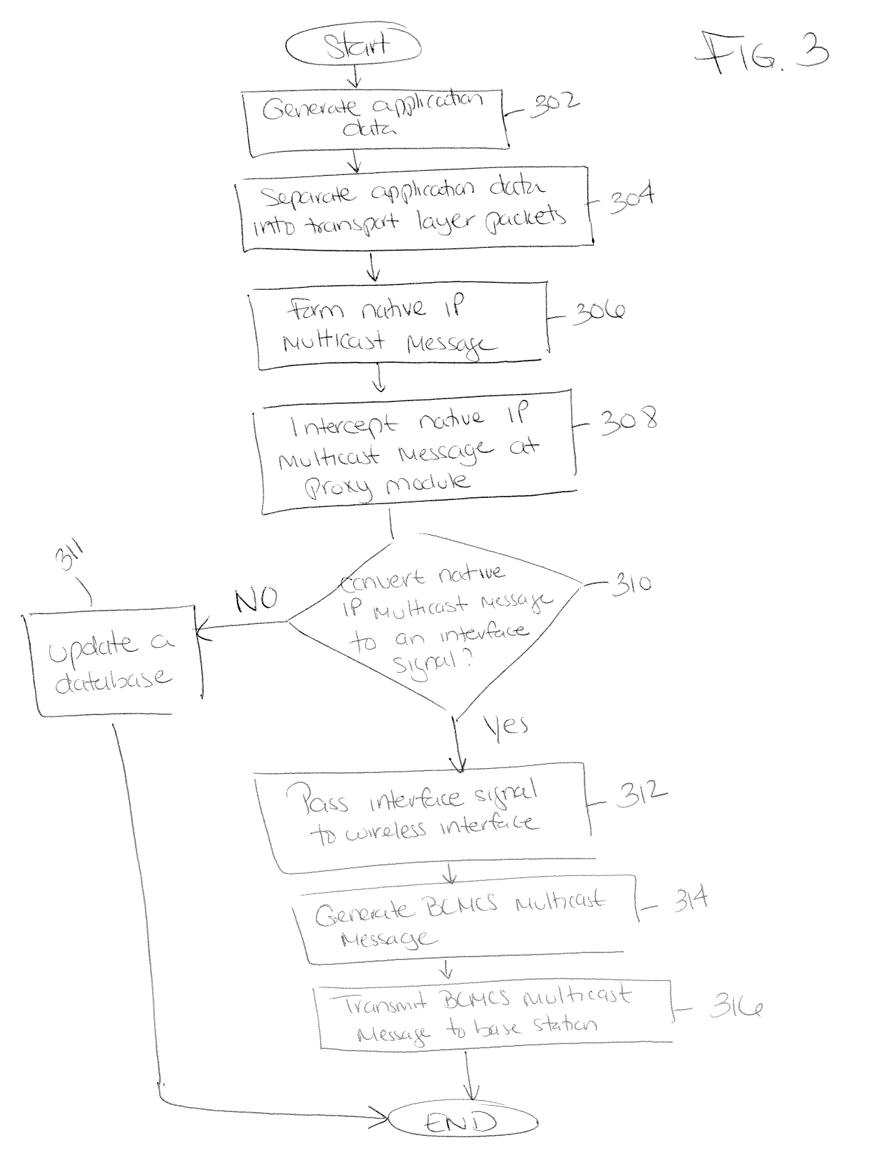

One exemplary embodiment of a multi-layer structure of a mobile station 140 according to the present disclosure is illustrated in FIG. 2. For purposes of this disclosure, the mobile station 140 is described in accordance with an IP protocol multi-layer structure. However, one skilled in the art would understand that the OSI model structure or any other multi-layer structure may also be used.

As shown in FIG. 2, the mobile station 140 includes an application layer 210, a transport layer 220, a network layer 230, and a link layer 240. The application layer 210 comprises one or more particular application programs that may be running on the mobile station 140. In accordance with the present disclosure, the application layer 210 comprises at least one native multicast application 212 that is configured to provide multicast functionality using native IP multicast protocols. As examples, the native multicast application 212 may be any web browser, web server, media player, group video application, group data application, or the like. As another example, the native multicast application 212 may also be an emergency alert system, such as the America's Missing: Broadcast Emergency Response (AMBER) alert system, which is used to multicast emergency bulletins in the event of child abduction. Of course, any other type of native multicast application may also be used.

The transport layer 220 interfaces the user applications on the application layer 210 to the network infrastructure and structures data messages for transmission. An exemplary type of transport layer protocol is a User Datagram Protocol (UDP), which provides a connectionless host-to-host communication path. Other well-known transport layer protocols may include Datagram Congestion Control Protocol (DCCP), Stream Control Transmission Protocol (SCTP), Transmission Control Protocol (TCP) and Real Time Protocol (RTP).

The network layer 230 performs network routing and forwarding, flow control, segmentation/desegmentation, error control functions, and the like. In one embodiment, the functionality of the network layer 230 is performed by the IP protocol. In accordance with the present disclosure, the network layer 230 also includes a native multicast protocol, such as IGMP, running on top of the IP protocol. As is well known-in the art, IGMP is used to manage the memberships of IP multicast groups. Specifically, via the IGMP protocol, each host in the system can join and leave multicast groups, as well as send IP datagrams to multicast groups. It should be understood that, for purposes of this disclosure, the IGMP protocol may be any version of the IGMP protocol such as, for example, IGMP version 0, IGMP version 1, IGMP version 2, or IGMP version 3. The specific standards for the formation of various IP packets using the IGMP protocol is described, in pertinent part, in Internet Engineering Task Force (IETF) Request for Comments (RFC) 966 and 988 (for IGMP version 0), IETF RFC 1054, 1112, and 1812 (for IGMP version 1), IETF RFC 2112, and 2236 (for IGMP version 2), and IETF RFC 3376 (for IGMP version 3), each of which is incorporated herein by reference.

The link layer 250 provides the method to move data packets from the network layer 230, and generally corresponds to the interface hardware. Thus, in one exemplary embodiment, the link layer 250 may be comprised of the EvDO interface 142. As mentioned above, the EvDO interface 142 is configured to manage multicast transmissions between the mobile station 140 and a base station 130 using the BCMCS protocol.

In accordance with the present disclosure, the mobile station 140 also includes a proxy module 240 operating above the link layer 250. More particularly, in one embodiment, the proxy module 240 is provided as a middleware layer configured to intercept multicast messages passed between the network layer 230 and the link layer 250. As explained further below, the proxy module enables interoperability between the native multicast application 212 and the EvDO interface 142.

In FIG. 3, one embodiment for transmitting a multicast message from the mobile station 140 using a native multicast application 212 is illustrated. In step 302, the native multicast application 212 generates data that is to be sent to a destination. The transport layer 220 separates the data into one or more data packets and appends a transport protocol header (e.g., UDP) to the data in step 304. The data packets are then passed to the network layer 230. In step 306, the network layer 230 forms native IP multicast messages by appending IGMP protocol headers to each of the data packets. In accordance with the present disclosure, the native IP multicast messages may be any type of message supported by the IGMP protocol, such as an IGMP report, IGMP query, a multicast IP datagram, an IGMP create group request/reply, an IGMP join request/reply, an IGMP leave request/reply, or the like.

The proxy module 240 intercepts each native IP multicast message as it is being passed down from the network layer 230 to the link layer 250 in step 308. If the proxy module 240 decides to convert the native IP multicast message to an interface signal having a format that can be recognized by the wireless interface 142 in step 3 10, it passes the interface signal to the link layer 250 in step 312. Thus, in the system described above, the proxy module may receive an IGMP multicast message, strip any IGMP formatting (such as IGMP headers) from the IGMP multicast message in order to obtain the relevant data in the IGMP multicast message, and pass the relevant data to the EvDO interface 142 using an EvDO-defined API call. The original native IP multicast message may also be suppressed and discarded to prevent the native IP multicast message from being passed to the EvDO interface 142. For example, if the IGMP multicast message is a multicast IP datagram, the proxy module 240 may intercept the multicast IP datagram, strip the IGMP-specific header information from the multicast IP datagram to obtain the application data contained in the multicast IP datagram, and pass the application data to the link layer 250 using an EvDO-defined API call. If, however, the proxy module 240 decides not to convert the native IP multicast message to an interface signal having a format that can be recognized by the wireless interface 142 in step 3 10, a database is updated in step 3 11 and the process ends. Similarly, if the IGMP multicast message is an IGMP report indicative of the mobile station's group memberships, the proxy module 240 may intercept the IGMP report, strip any IGMP formatting from the group membership information, and pass the group membership information to the link layer 250 using an EvDO-defined API call.

In step 314, upon receiving the interface signal, the wireless interface 142 generates a BCMCS message that is functionally equivalent to the native IP multicast signal. For example, if the native IP multicast signal was originally a multicast IP datagram containing application data, the BCMCS message may be a BCMCS datagram containing the same application data. Similarly, if the native IP multicast message was originally an IGMP report containing group membership information, the BCMCS message may be a BCMCS registration message containing the same group membership information. It should be noted that if IGMPv3 is used, the group membership information will include a list of source address filters when supported by later developed EvDO standards. The specific BCMCS message structure and format is provided in 3GPP2 C.S0054-0 (“cdma2000 High Rate Broadcast-Multicast Packet Data Air Interface Specification”), which is incorporated herein by reference.

In step 316, the wireless interface transmits the BCMCS message to a base station. The BCMCS message is then received and processed by the base station in accordance with well-known procedures and methods.

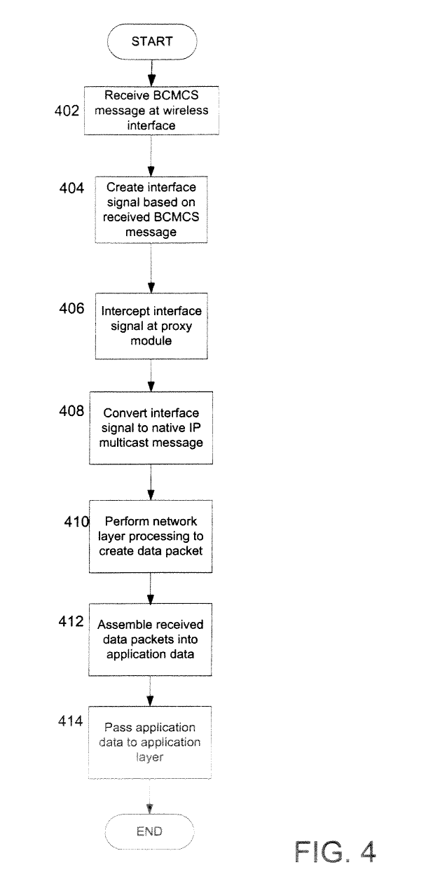

Turning to FIG. 4, one embodiment of a method for receiving a multicast message in a mobile station 140 using a native multicast application is illustrated. In step 402, the EvDO interface 142 receives a BCMCS message. The BCMCS message may be any type of BCMCS message for managing multicast communications as defined in 3GPP2 C.S0054-0, such as a BCMCS datagram, a BCMCS flow identification message, or the like. In step 404, the EvDO interface 142 creates an interface signal (e.g., an EvDO-defined API call) based on the received BCMCS message and sends the interface signal up from the link layer 250. The proxy module 240 intercepts the interface signal as it is being passed up from the link layer 250 in step 406. In step 408, the proxy module 240 converts the interface signal to a native IP multicast message that is functionally equivalent to the received BCMCS message, and which contains any data that was received in the BCMCS message. For example, after receiving a message to register with a system to continue to monitor the IP multicast flow, the proxy module may generate a IGMP query message to the upper layers. The native IP multicast message is then passed to the network layer 230. In step 410, the network layer 230 performs network layer processing by ensuring that the IP multicast message has reached the correct IP address, removing the IGMP-specific header information. The resultant packet is then passed up to the transport layer 220. The transport layer 220 receives and assembles a group of received packets to form application data in step 412. The application data is passed up to the application layer 210 in step 414, where it is processed by the native multicast application 212.

It is of course understood that if the received BCMCS message originally received in step 402 is of a type that requires a response, the native multicast application 212 may trigger an appropriate response IGMP message to be created, which would then be converted using the process of FIG. 3 and provided to the EvDO interface for transmission to the base station 130. For example, the received BCMCS message may request the mobile station 140 to identify whether it is still interested in receiving a particular multicast communication. Using the process described in FIG. 4, the BCMCS message is converted to an IGMP query that is provided to the native multicast application. The native multicast application 212 may then trigger a response IGMP message to be created indicating whether the native multicast application 212 is still interested in receiving the multicast communication. This response IGMP message is converted using the process of FIG. 3 and provided to the EvDO interface. Alternatively, rather than converting the BCMCS message to an IGMP query and sending the IGMP query the native multicast application 212, the proxy module 240, upon receiving the interface signal corresponding to the BCMCS message, may also be configured to automatically generate an appropriate response message and provide the response message to the EvDO interface. This may be possible if, for example, prior to the receipt of the BCMCS message, the native multicast application 212 has previously provided the proxy module, via an IGMP message or otherwise, with information indicating whether the native multicast application is interested in receiving the multicast communication.

By means of the aforementioned disclosure, there is provided a system and method for converting native multicast messages to interface-specific signals, and vice versa. As the above disclosure may be provided transparently to the application and the user, mobile stations employing wireless interfaces (such as EvDO interfaces) may be readily used with native multicast applications operating on native IP multicast protocols.

Further advantages and modifications of the above described system and method will readily occur to those skilled in the art. For example, while the present disclosure has been described with regards to a CDMA2000 system using EvDO and BCMCS protocols, it is understood that the present disclosure may also be used in other types of systems where the wireless interface does not support native IP multicast. The present disclosure may also be used to convert other types of native IP protocol messages other than IGMP. It is also understood that while the proxy module is shown as being positioned between the network layer and the link layer, the proxy module may alternatively be positioned in other portions of the multi-layer structure between the application and the link layer.

The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure cover all such modifications and variations provided they come within the scope of the following claims and their equivalents.

What is claimed is:

1. A method for enabling operation of a Internet Protocol (IP) multicast application in a mobile station having a wireless interface that does not support native IP multicast, the method comprising:
creating a first multicast message using a native IP multicast protocol, the first multicast message including data corresponding to a multicast application;
obtaining the first multicast message at a proxy module;
converting the first multicast message to an interface signal having a format that can be recognized by the wireless interface;
sending the interface signal to the wireless interface;
generating, by the wireless interface, a second multicast message in response to receiving the interface signal, the second multicast message being generated using a wireless broadband data protocol different from the IP multicast protocol, the second multicast message providing a multicast function substantially similar to that of the first multicast message; and
transmitting the second multicast message to a base station.

2. The method of claim 1 wherein creating a first multicast message includes creating the first multicast message at a network layer, and wherein obtaining the first multicast message includes intercepting the first multicast message as it is being passed from the network layer to a link layer.

3. The method of claim 1 wherein the wireless interface comprises an Evolution Data Optimized (EvDO) interface, and the wireless broadband data protocol comprises a Broadcast and Multicast Service (BCMCS) protocol.

4. The method of claim 1 wherein the native IP multicast protocol includes an Internet Group Management Protocol (IGMP).

5. The method of claim 1 wherein converting the first multicast message to the interface signal includes stripping IGMP formatting from the first multicast message to obtain the data in the first multicast message, and creating an interface signal including at least a portion of the data.

6. The method of claim 5 wherein converting the first multicast message to the interface signal includes discarding the first multicast message after obtaining the data in the first multicast message.

7. The method of claim 1 wherein the interface signal is an Application Program Interface (API) call.

8. A method for enabling operation of a native Internet Protocol (IP) multicast application in a mobile station having a wireless interface that does not support native IP multicast, the method comprising:
receiving, at the wireless interface, a first multicast message using a wireless broadband protocol;
generating, by the wireless interface, an interface signal based on the received first multicast message;
obtaining the interface signal at a proxy module;
converting the interface signal to a second multicast message using a native IP multicast protocol, the second multicast message providing a multicast function substantially similar to that of the first multicast message; and
passing the second multicast message to a multicast application.

9. The method of claim 8 wherein the wireless interface comprises an Evolution Data Optimized (EvDO) interface, and the wireless broadband data protocol comprises a Broadcast and Multicast Service (BCMCS) protocol.

10. The method of claim 8 wherein the native IP multicast protocol includes an Internet Group Management Protocol (IGMP).

11. The method of claim 8 wherein passing the second multicast message to the native multicast application, includes passing the second message to the native multicast application via a network layer and a transport layer.

12. A mobile station in a communication system comprising:
an application layer comprising a multicast application;
a network layer for creating a first type of multicast messages using an IP multicast protocol, the first type of message containing data corresponding to the multicast application;
a link layer comprising a wireless interface for wirelessly communicating with a base station using a wireless broadband protocol; and
a proxy module operating at least one layer above the link layer; the proxy module being configured to obtain a first type of multicast message created by the network layer, convert the first type of multicast message to an interface signal that can be recognized by the wireless interface, and pass the interface signal to the wireless interface,
whereby, upon receiving the interface signal, the wireless interface creates a second type of multicast message compliant with the wireless broadband protocol, the second type of multicast message having functionality that is substantially similar to that of the first type of multicast message.

13. The mobile station of claim 12 wherein the wireless interface is further configured to generate an interface signal upon receiving a second type of multicast message from the base station; and wherein the proxy module is configured to obtain the interface signal from the wireless interface, convert the interface signal to a first type of multicast message compliant with the IP multicast protocol, and pass the interface signal to the multicast application.

14. The mobile station of claim 13 wherein the proxy module is further configured to, upon obtaining the interface signal corresponding to the second type of multicast message from the wireless interface, generate a response message and provide the response message to the wireless interface as an interface signal.

15. The mobile station of claim 12 wherein the wireless interface comprises an Evolution Data Optimized (EVDO) interface, and the wireless broadband data protocol comprises a Broadcast and Multicast Service (BCMCS) protocol.

16. The mobile station of claim 12 wherein the interface signal is an Application Program Interface (API) call.

17. The mobile station of claim 12 wherein the first type of multicast message is an IGMP multicast message.

18. The mobile station of claim 17 wherein the proxy modules is further configured to strip IGMP formatting from the first multicast message to obtain the data in the first multicast message, and creating an interface signal including at least a portion of the data.

19. The mobile station of claim 12 wherein the proxy module is a middleware application that operates between the link layer and the network layer in a multi-layer network structure.

20. The mobile station of claim 12 wherein the mobile station is one of a cellular phone, Personal Digital Assistant, video terminals, and portable computer.
